(19) United States
(12) Patent Application Publication
(10) Pub. No.: US 2013/0211856 A1
(43) Pub. Date: Aug. 15, 2013

(54) SYSTEMS AND METHODS FOR GENERATING OUTCOME MEASURES

(71) Applicants: Scott Richard Pribyl, Overland Park, KS (US); Jarrod David Townsend, Overland Park, KS (US)

(72) Inventors: Scott Richard Pribyl, Overland Park, KS (US); Jarrod David Townsend, Overland Park, KS (US)

(73) Assignee: ENOVATION, LLC, Overland Park, KS (US)

(21) Appl. No.: 13/739,999

(22) Filed: Jan. 11, 2013

Related U.S. Application Data
(60) Provisional application No. 61/585,360, filed on Jan. 11, 2012.

(51) Int. Cl. G06F 19/00

(52) U.S. Cl. CPC G06F 19/322
USPC 705/3

(57) ABSTRACT

Systems and methods for automatic generation of one or more outcome measures are disclosed. The outcome measures may be displayed as a single one page summary, which may be provided to a specialty physician or other medical professionals. Additionally, the outcome measures summary may be reviewed independently, and/or integrated with existing electronic medical reports, and may be used to initiate other medical activities, such as e-prescriptions and/or medical insurance authorization.

### CROSS-REFERENCE TO RELATED APPLICATIONS

This application takes priority to U.S. Patent Application No. 61,585,360, filed Jan. 11, 2012, and entitled Systems And Methods For Generating Outcome Measures, the entire contents of which are incorporated herein by reference.

### TECHNICAL FIELD

Aspects of the present disclosure relate to methods and systems for receiving, aggregating, managing, and distributing medical data to medical professionals, and in particular, to methods and systems for generating patient outcome measures.

### BACKGROUND

Hospitals, doctor offices and other patient care facilities aggregate large amounts of medical data that may be used in patient diagnosis and treatment. For example, many hospital and/or doctor offices include patient monitoring devices, such as sensors, processing equipment, and displays for obtaining and analyzing medical data for patients. Doctors and other medical personnel use the medical data for a variety of purposes, such as diagnosing illnesses, prescribing treatments, and determining whether to increase the level of medical care given to patients once treatment has begun.

Typically, any medical data collected for a given patient is recorded as an electronic medical record (“EMR”). An EMR represents a standardized form of medical data and is commonly used in the medical industry to create and maintain a medical history for patients. Current EMR providers focus on holistic medicine using complex and expensive legacy systems to generate a single EMR for all physicians, requiring specialty physicians to parse through large amounts of medical information. Parsing through such information may present many challenges to specialty physicians, as it is time-consuming, expensive, and laboring. It is with these concepts in mind, among others, that various aspects of the present disclosure were conceived.

### SUMMARY

One aspect of the present disclosure involves an outcome measures generation system. The system includes at least one processor. The system further includes an assessment application executable by the at least one processor to receive a plurality of patient data inputs for a particular patient and receive a plurality of physician assessments corresponding to the particular patient. The assessment application is executable by the at least one processor to receive lab data from a lab system corresponding to the particular patient. The assessment application is executable by the at least one processor to generate a plurality of outcome measures based on the plurality of patient data inputs, the plurality of physician assessments and the lab data, each outcome measure of the plurality of outcome measures comprising an indication of patient treatment. The assessment application is executable by the at least one processor to generate for display, a consolidated outcome measures summary comprising at least one of the plurality of outcome measures.

Another aspect of the present disclosure involves an outcome measures generation system. The system includes at least one processor. The system further includes an assessment application executable by the at least one processor to receive a plurality of patient data inputs for a particular patient and receive a plurality of physician assessments corresponding to the particular patient. The assessment application is executable by the at least one processor to receive lab data from a lab system corresponding to the particular patient. The assessment application is executable by the at least one processor to generate a plurality of outcome measures based on the plurality of patient data inputs, the plurality of physician assessments and the lab data, each outcome measure of the plurality of outcome measures comprising an indication of patient treatment. The assessment application is executable by the at least one processor to generate for display, a consolidated outcome measures summary comprising at least one of the plurality of outcome measures. The assessment application is executable by the at least one processor to transmit the consolidated outcome measures summary to an insurance provider and the particular patient.

Aspects of the present disclosure include methods for generating outcome measures. The method includes receiving, at at least one processor, a plurality of physician assessments corresponding to the particular patient. The method further includes receiving, at the at least one processor, lab data from a lab system corresponding to the particular patient. The method includes generating, at the at least one processor, a plurality of outcome measures based on the plurality of patient data inputs, the plurality of physician assessments and the lab data, each outcome measure of the plurality of outcome measures comprising an indication of patient treatment. The method further includes generating for display, at the at least one processor, a consolidated outcome measures summary comprising at least one of the plurality of outcome measures.

### BRIEF DESCRIPTION OF THE DRAWINGS

FIG. 1A is a block diagram illustrating a computing environment including a processing device for executing an assessment application, according to aspects of the present disclosure.

FIG. 1B is a block diagram illustrating a user device according to aspects of the present disclosure.

FIG. 2 is a block diagram illustrating a processing device configured with an assessment application, according to aspects of the present disclosure.

FIG. 3 is a flowchart illustrating an example process for generating an outcome measures summary, according to aspects of the present disclosure.

FIGS. 4-26 illustrate various screen shots of patient data entry forms according to aspects of the assessment application.

### DETAILED DESCRIPTION

Aspects of the present disclosure describe systems and corresponding methods for receiving, aggregating, managing, and distributing medical data to medical professionals, for example, to a physician to perform outcome measure based evaluations. In particular, the methods and systems described provide the ability to collect medical data related to the diagnosis, care, and treatment of one or more medical patients. The medical data may include for example, medical data describing the condition and diagnosis of a medical patient, medical insurance data, prescription data, and/or any other type of medical data corresponding to a particular patient. A user, such as a patient and/or a physician, may interact with one or more graphical user interfaces to enter various types of medical data corresponding to the particular patients. Subsequently, the medical data may be processed to generate one or more outcome measures that may be presented in a one-page summary output.

Outcome measures describe the results of one or more medical tests that are used to objectively determine the baseline function of a patient at the beginning of treatment and/or during treatment. Once treatment has commenced, the same or similar tests may be used to determine progress and treatment efficacy. Additionally, outcome measures may be used as a measure of change, representing the difference from one point in time (such as before an intervention or treatment) to another point in time (such as following an intervention or treatment). Finally, outcome measures describe the tools and metrics used to assess change in a patient over time. Physicians are required to make many medical decisions such as determining whether and when a patient is likely to experience a medical condition and further how a patient should be treated once the patient has been diagnosed with the condition. Outcome measures may be used to aid physicians and/or other medical personnel when making such determinations.

In one embodiment, outcome measures may be used by Rheumatologists to diagnose rheumatic diseases. Rheumatologists are medical professionals that specialize in diagnosing and treating disorders affecting the loco-motor system including joints, muscles, cognitive tissues, soft tissues, and the like. Common diseases include arthritis, autoimmune, pain disorders, affecting the joints, and osteoporosis. Conventional Rheumatology systems and methods generally rely on outdated medical data when attempting to generate or otherwise calculate outcome measures. For example, typically Rheumatologists must phone a medical lab to retrieve test results or wait for the medical lab to send a report by courier or fax to the physician's office, both of which are time consuming and inefficient, and ultimately lead to the use of outdated data. As another example, many Rheumatologists, when generating outcome measures, use patient evaluation forms that were completed by the patient months earlier. Such patient data is typically out of date because many different changes in the patient's symptoms, feelings, and overall health may have occurred between the time the patient evaluation form was originally completed and the time at which the Rheumatologists need the data for generating outcome measures.

Aspects of the present disclosure provide systems and methods that enable the generation of outcome measures based on real-time and/or up to data medical data, resulting in increased patient care treatment, treatment efficiency, and accuracy. More particularly, one or more outcome measures may be generated based on the most up to data patient data and/or on medical lab data received in near real-time. The outcome measures may be presented in a single user-friendly one page summary, such as a PDF, user interface screen, or other output that may be used to initiate other medical activities, such as an e-prescription and/or initiate insurance authorization procedures. Subsequently, the insurance provider may use the outcome measures to adjudicate insurance claims in a quick and efficient manner. While the foregoing may include examples referring to Rheumatologists, it is contemplated that the method and systems described herein may be applied to other treatments and diseases used by any type of physician, specialty physician or other type of medical professional, such as dermatologists, oncologists, urologists, psychiatrists, etc.

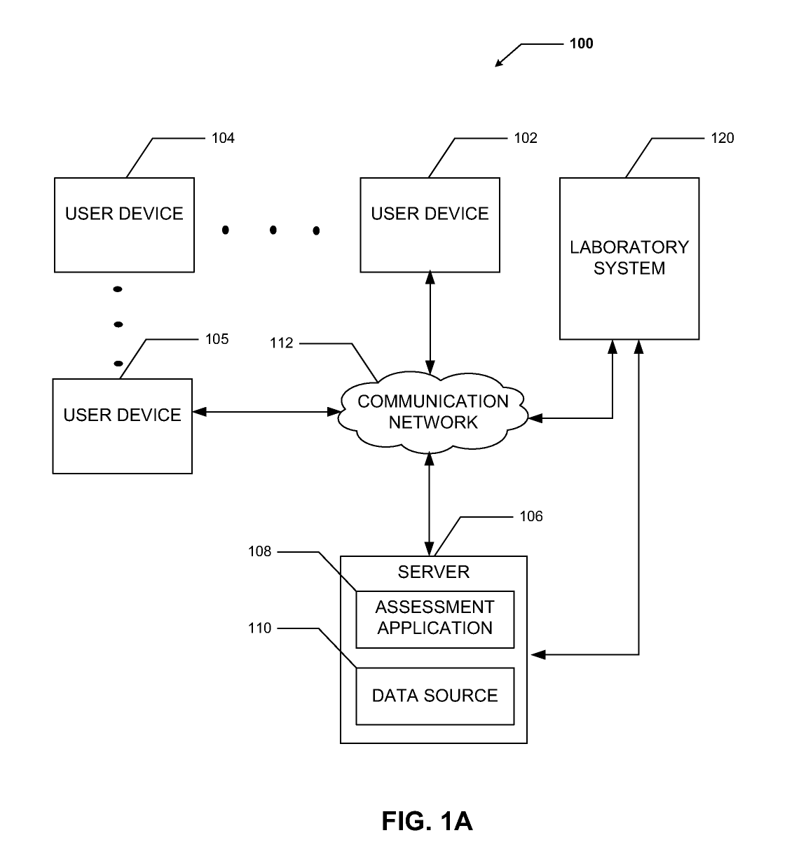

FIG. 1A illustrates an example computing environment 100 that includes a server 106 configured to generate various medical outcome measures, according to aspects of the present disclosure. In various aspects, the server 106 may include an assessment application 108 including various instructions, functions, and/or processes which, when executed, generate various medical outcome measures and a data source 110 for storing the generated outcome measures. More particularly, the server 106 includes one or more processors and memory that execute the assessment application 108 to generate an outcome measures report, pdf, file, summary, and/or other document or other output that summarizes the medical characteristics of one or more patients. Subsequently, the outcome measures may be exported, saved, or otherwise stored in the data source 110.

A user may interact with the various components of one or more client devices (e.g., client devices 102-105) to provide various inputs to the server 106, which may be processed to generate the output measures generated by the server 106. FIG. 1B depicts an exemplary embodiment of the one or more user devices 102-105, according to one aspect of the present disclosure. As illustrated, the one or more user devices 102-105 may be a computing or processing device that includes one or more processors 122 and memory 124 and is configured to receive data and/or communications from, and/or transmit data and/or communications to the server 106 via the communication network 112. For example, the one or more user devices 102-105 may be a laptop, a personal digital assistant, a tablet computer, a standard personal computer, or another processing device. The one or more user devices 102-105 may include a display 120, such as a computer monitor, for displaying data and/or graphical user interfaces. The one or more user devices 102-105 may also include an input device 116, such as a keyboard or a pointing device (e.g., a mouse, trackball, pen, or touch screen) to enter data into or interact with graphical user interfaces.

Each one or more user devices 102-105 may also include a graphical user interface (or GUI) application 118, such as a browser application, to generate a graphical user interface 114 on the display 120. The graphical user interface 114 enables a user of the one or more user devices 102-105 to interact with various data entry forms to enter patient data, medical data, medical related information, insurance data, prescription data, and/or any other data related to patient diagnosis, care, and/or treatment into the assessment application 108 to generate one or more outcome measures for patients. After entering the patient data, medical data, medical related information, insurance data, and/or prescription data, etc., the data is transmitted to the server 106.

The server 106 is configured to receive data from and/or transmit data to the one or more user devices 102-105 through the communication network 112, which may be the Internet, an intranet, or another wired and/or wireless communication network. For example, communication network 112 may include a Mobile Communications network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and/or wireless networks may also be used.

The server 106 is also configured to receive data from a medical laboratory system 120 (e.g., Quest Diagnostics) provided by any suitable computer that provides lab data to the server 106 through the communication network 112. In particular, in response to a request for medical data corresponding to a particular patient, the medical laboratory system 120 is configured to provide lab data, which includes any type of medical test data, information, and/or completed by the medical laboratory 120 and any corresponding acknowledgements, such as confirmations and/or rejections in response to any request for lab data. Alternatively, the medical laboratory system 120 may periodically provide such lab data to the server 106 without a request.

In one embodiment, the medical data received from the medical laboratory system 120 may include one or more lab values. For example, if the physician is a Rheumatologist, the lab values may include an erythrocyte sedimentation rate (“ESR”) value, which measures how much inflammation is in the body and is commonly used to help detect conditions associated with acute and chronic inflammation, including infections, cancers, and autoimmune diseases. The lab values may include a C-Reactive Protein (“CRP”) value, which measures the concentration in blood serum of a special type of protein produced in the liver that is present during episodes of acute inflammation or infection. The lab values may include an Rheumatoid Factor (“RF”) value that measures the amount of the RF antibody present in the blood, a high level of which can be caused by several autoimmunine and related diseases. The lab values may include an anti-cyclic citrullinated peptide antibody (“Anti-CCP”), which is a value that may be analyzed to confirm a diagnosis of rheumatoid arthritis. A high level of Anti-CCP, it typically indicates that the patient is at increased risk for damage to the joints. Low levels of the Anti-CCP are less significant. It is contemplated that any type of medical lab measurement value(s) may be received from the medical laboratory system 112, including Complete Blood Count (CBC), Comprehensive Metabolic Profile (CMP), Liver Function Test (LFT), Alanine aminotransferase (“ALT”), which is blood test is typically used to detect liver injury, and any other lab values related Rheumatology, or other types of medicine. According to one aspect, the lab values are communicated from lab equipment to directly the server 106.

According to another aspect, the lab value data is communicated from lab equipment to the server 106 via and intermediate device (not shown). In one such aspect, data may be communicated to the intermediate device via formatted messaging using a variety of transfer protocols including, but not limited to, REST, JSON, SOAP, XML, OCR, CCR. Once the lab values device are received back from the labs into intermediate device, the data is structured to be messaged back into server 106and update lab values.

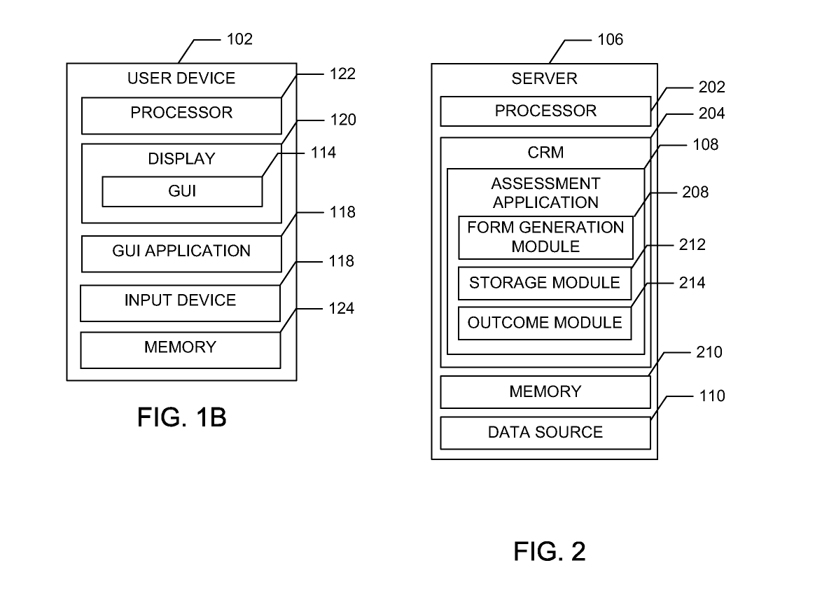

FIG. 2 is a block diagram illustrating hardware and/or software components of the server 106 according to aspects of the present disclosure. In one aspect, the server 106 may include a processor 202 that may be used to execute the assessment application 108 to generate outcome measures and/or a one-page outcome measures summary. The processor 202 may include memory and/or be in communication with a memory 210, which may include volatile and/or non-volatile memory.

The server 106 may include the data source 110, such as a database. The data source 110 may be a general repository of data, including but not limited to, patient data, medical data, medical related information, insurance data, prescription data, outcome measures data and/or any other data related to patient diagnosis, care, and/or treatment of a patient. For example, the data source 110 may include patient data describing the general health of a particular patient received at the one or more user devices 102-105. Patient data may include the patient's name, basic measurements (i.e. height, weight, body fat percentage, etc.), vital signs, etc. In one aspect, patient data may include a unique patient identifier that distinctly identifies a patient from another patient. The data source 110 may include memory and one or more processors or processing systems to receive, process, query and/or transmit communications and store and/or retrieve such data. In another aspect, the data source 110 may be a database server. While the data source 110 is illustrated as being within the server 106, it is contemplated that the data source 110 may be located remotely to the server 106, such as within a database of another computing device or system having at least one processor and volatile and/or non-volatile memory.

According to one aspect, the server 106 includes a computer readable medium (“CRM”) 204, which may include computer storage media, communication media, and/or another available media medium that can be accessed by the processor 202. For example, CRM 204 may include non-transient computer storage media and communication media. By way of example and not limitation, computer storage media includes memory, volatile media, nonvolatile media, removable media, and/or non-removable media implemented in a method or technology for storage of information, such as machine/computer readable/executable instructions, data structures, program modules, or other data. Communication media includes machine/computer readable/executable instructions, data structures, program modules, or other data and include an information delivery media or system.

In one embodiment, the CRM may store executable instructions to implement the assessment application 108. Generally, program modules include routines, programs, instructions, objects, components, data structures, etc., that perform particular tasks or implement particular abstract data types. For example, in various embodiments, the assessment application 108 may include a form generation module 208 that receives data to generate outcome measures.

In one embodiment, the form generation module 208 may transmit instructions that may be processed and/or executed to display one or more interactive interfaces and/or input forms (e.g., a user-interface) on the one or more user devices 102-105. A user, such as a physician and/or a patient, interacts with the one or more input forms to enter patient data and/or medical data and optionally generate a storage request. The user-interfaces may include various interactive elements, such as buttons, forms, fields, selections, inputs, streams, etc., for receiving the patient data and/or medical data. In one particular embodiment, a request to access medical data corresponding to a particular patient may be received from a user engaging the server 106, such as a physician, and in response, the form generation module 210 may generate, or otherwise display, the one or more interactive interfaces and/or input forms.

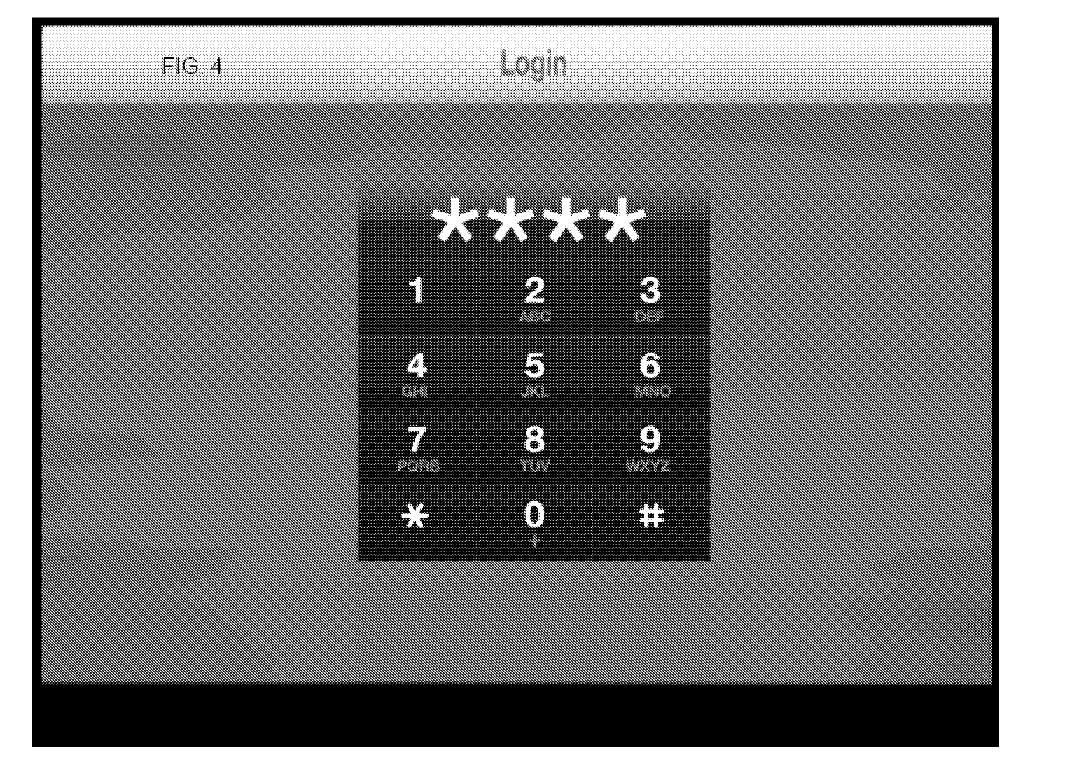

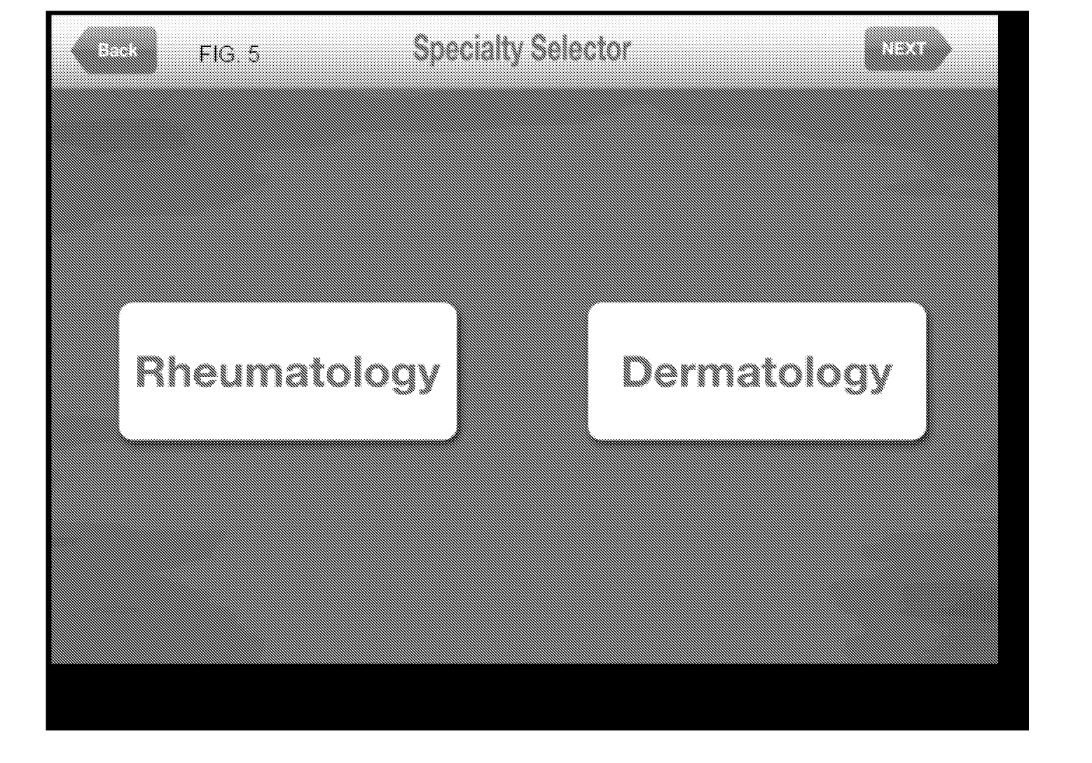

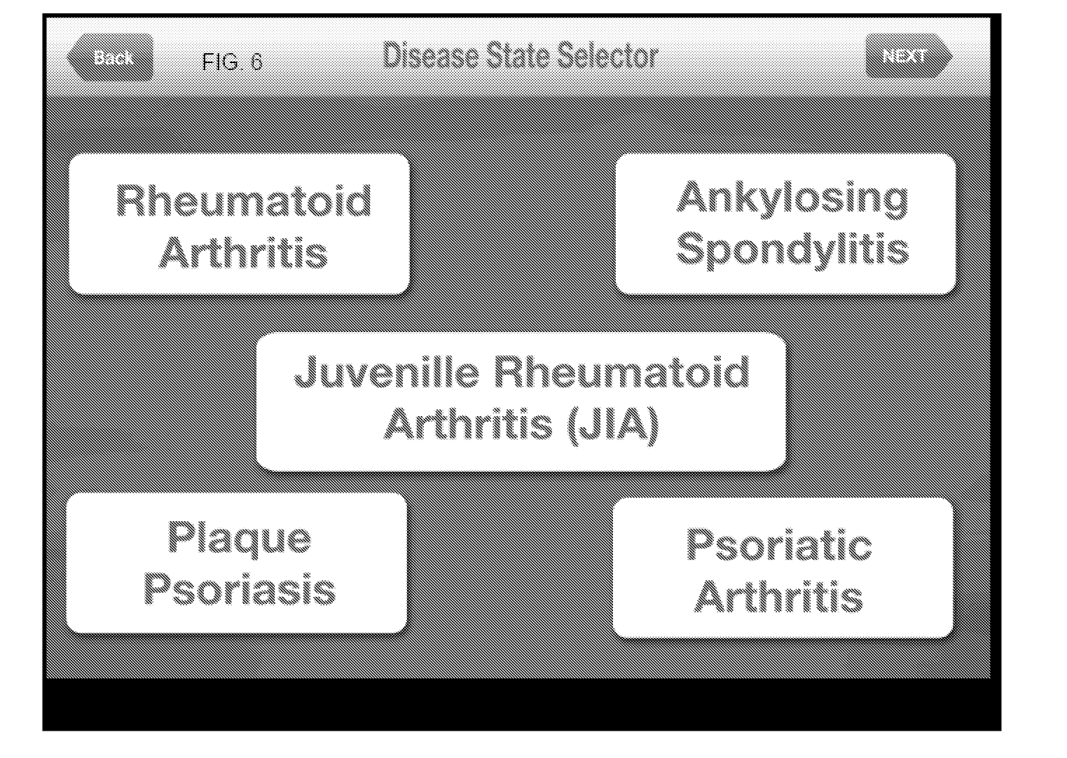

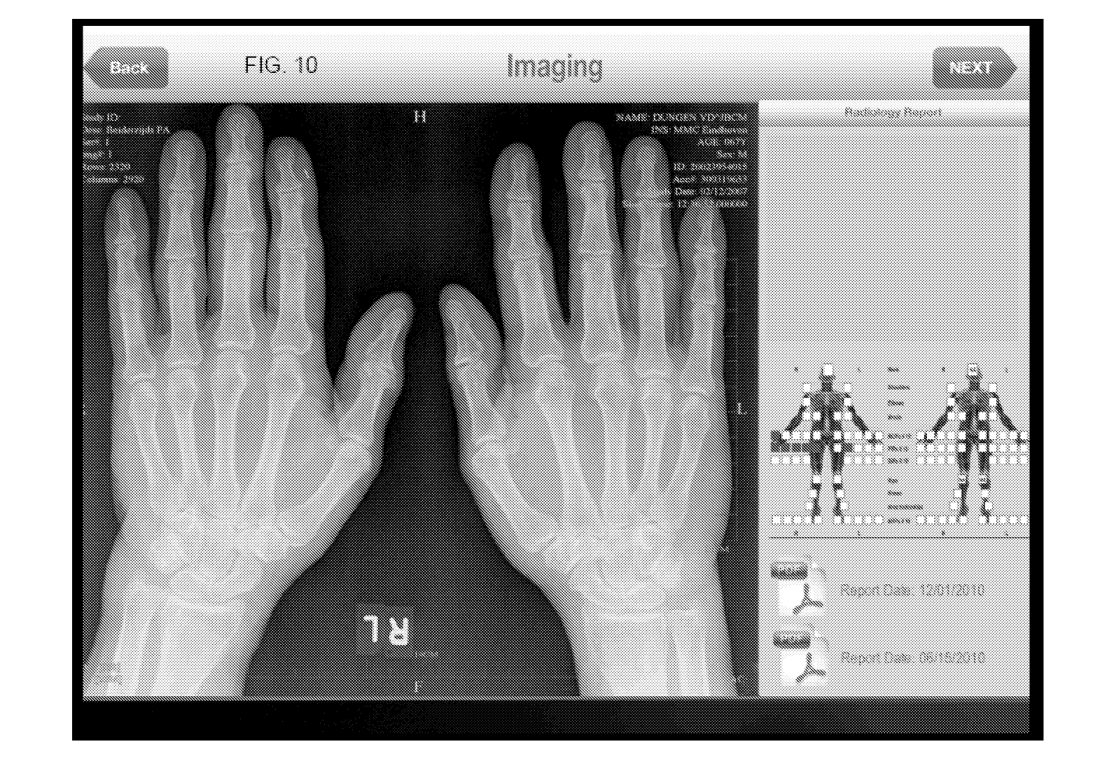

FIGS. 4-13 depict exemplary screen shots of the one or more input forms transferred to the one or more user devices 102-105 by the form generation module 208. The user of the one or more user devices 102-105 interacts with the various input data forms to enter patient data, insurance data, medication data, and/or other data related to patient diagnosis, care, and/or treatment, which may be used to generate the one or more outcome measures.

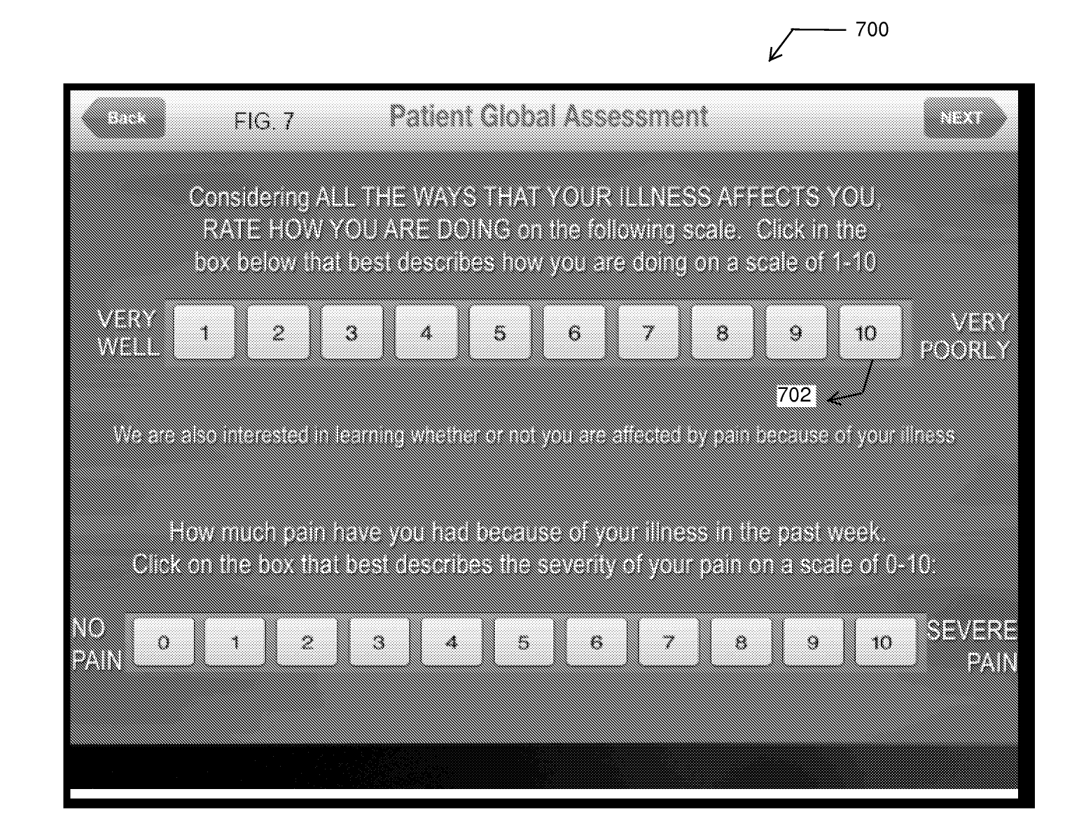

For example, FIG. 7 depicts a patient global assessment data input form 700. The user of the one or more user devices 102-105 interacts with the patient global assessment data input form to enter patient global assessment data describing how a patient is feeling overall in regards to and/or the pain that a patient may be suffering. As illustrated, a user, such as a patient, may interact with the patient global assessment data input form 700 to indicate on a scale from 1 to 10—1 being “very well” and 10 being “very poorly”—that the patient is doing very poorly 702. In one embodiment, the patient global assessment may also be described as a

“Global Health Assessment” or “GH,” outcome measure, which may be a variable included in one or more of the DAS outcome measures and/or DAS outcome measure calculations as will be described below.

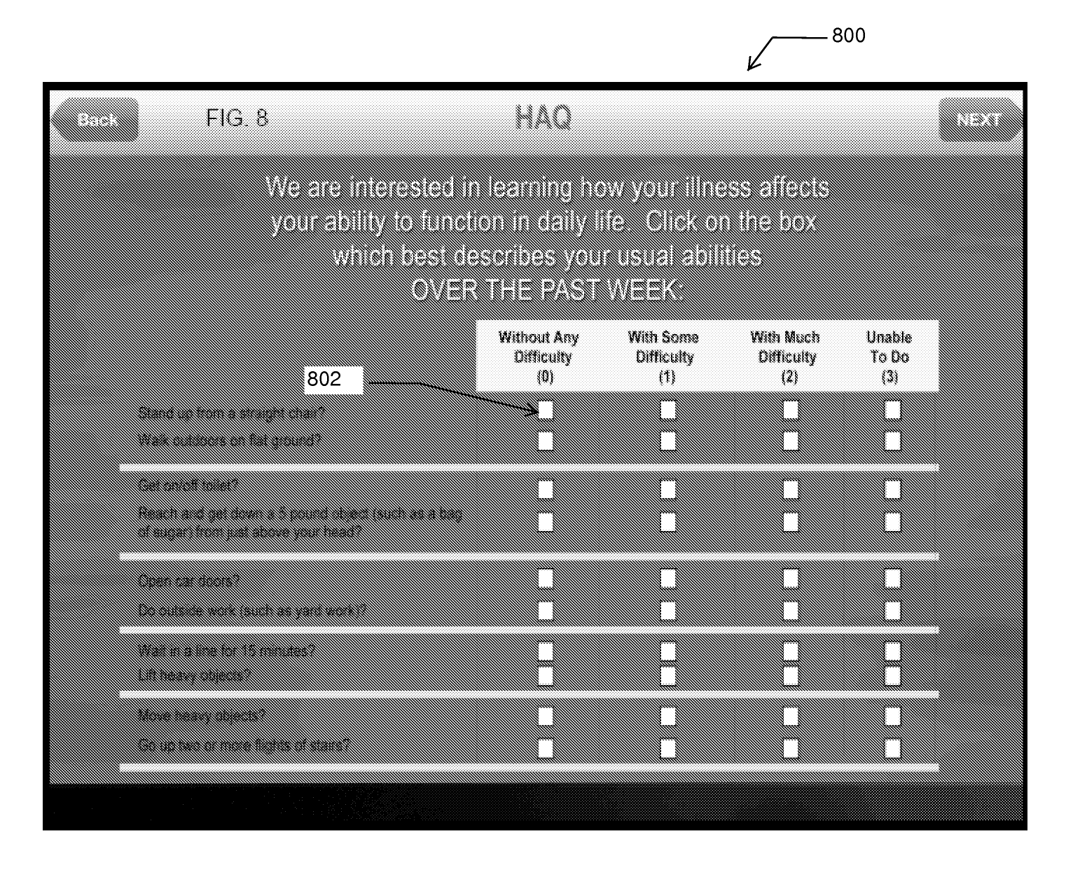

As another example, FIG. 8 depicts a health assessment questionnaire input form 800 (“HAQ”). As illustrated, a user of the one or more user devices 102-105, such as a patient, may interact with the health assessment questionnaire input form to enter health assessment questionnaire data describing one or more actions that a patient may or may not be able to perform because of the patient's illness. For example, as illustrated, the user may interact with the health assessment questionnaire input form 800 that the patient is capable of standing up from a straight chair without any difficulty at 802. Subsequently, an HAQ index outcome measure may be generated based on the health assessment questionnaire data.

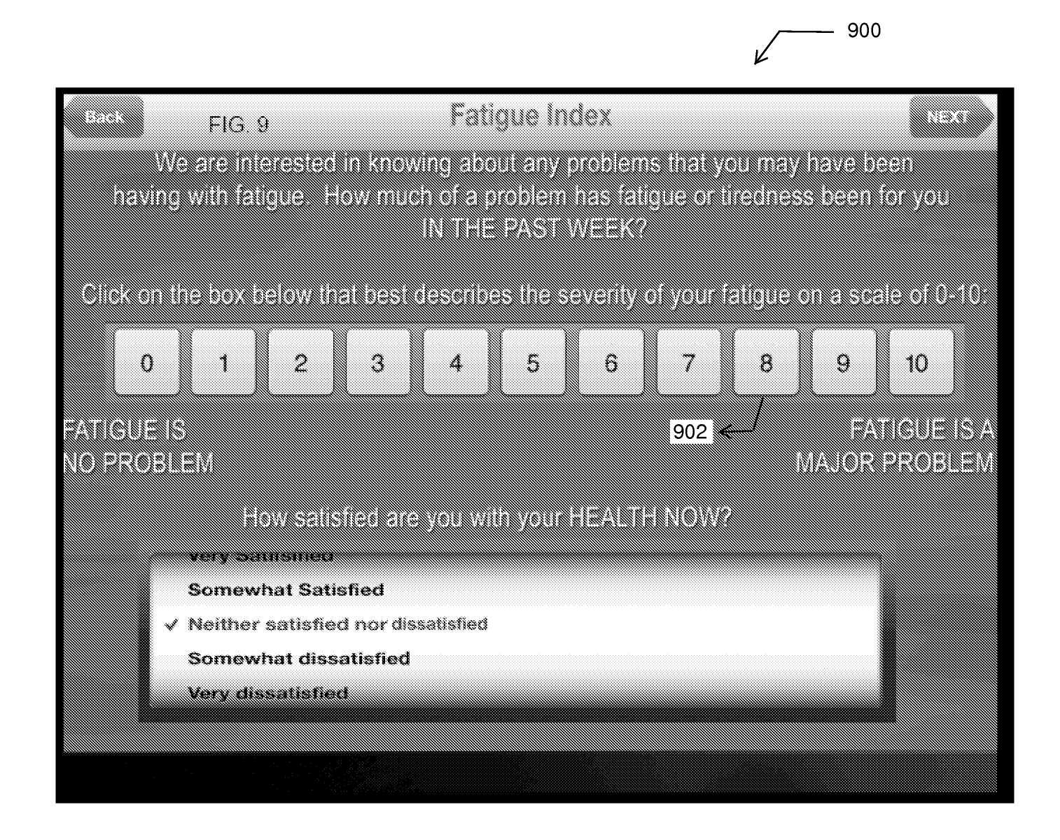

FIG. 9 depicts a Fatigue Index input form 900. The user of the one or more user devices 102-105 interacts with the Fatigue Index input form 900 to enter Fatigue Index data describing the severity of fatigue of the patient. For example, as illustrated, a user, such as a patient, may interact with the Fatigue Index input form 900 to indicate on a scale from 1 to 10—1 being “fatigue is no problem” and 10 being “fatigue is a major problem”—that fatigue is a problem of level eight at 902. Subsequently, a Fatigue Index outcome measure may be generated based on the Fatigue Index data.

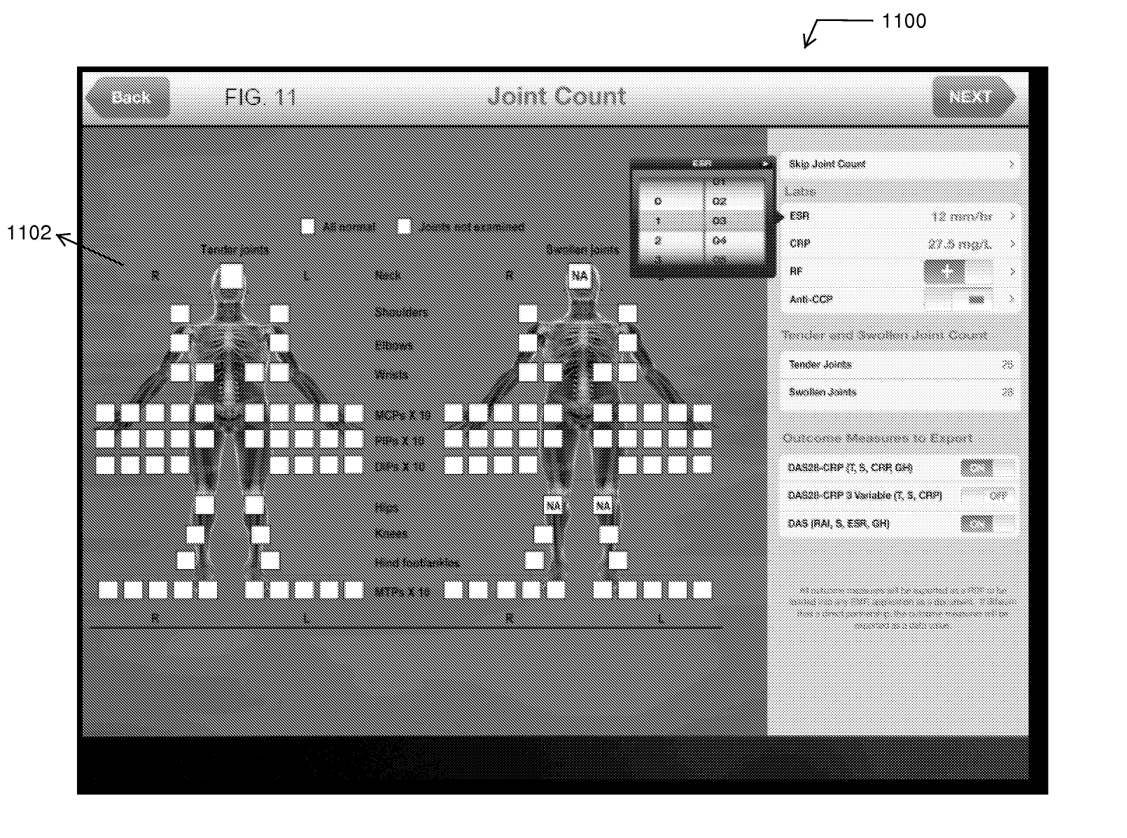

FIG. 11 depicts a Joint Count input form 1100. The user of the one or more user devices 102-105 interacts with the Joint Count input form to enter joint count data that accounts for the number of tender joints, swollen joints, and/or normal joints that a patient may have. For example, as illustrated, a user, such as a physician, may interact with Joint Count input form 1100 to identify each joint on a human body model 1102 that is considered to be tender.

In one aspect, the joint count data may be used to calculate a disease activity score (“DAS”) for the patient, which is a physician assessment used to measure the level of disease activity in people with rheumatoid arthritis. For example, the patient data may be used to calculate a DAS score using a 3 variable and/or 4 variable DAS equation, such as DAS28(4)=(0.56*sqrt(t28)+0.28*sqrt(sw28)+0.70*In(ESR)+0.014*GH, where the variable GH is the patient Global Health assessment, where t28 represents the number of tender joints, sw28 represents the number of swollen joints, and ESR represents the erythrocyte sedimentation rate value. Other DAS equations may also be used to calculate a DAS for a patient using joint data, as are generally known in the art.

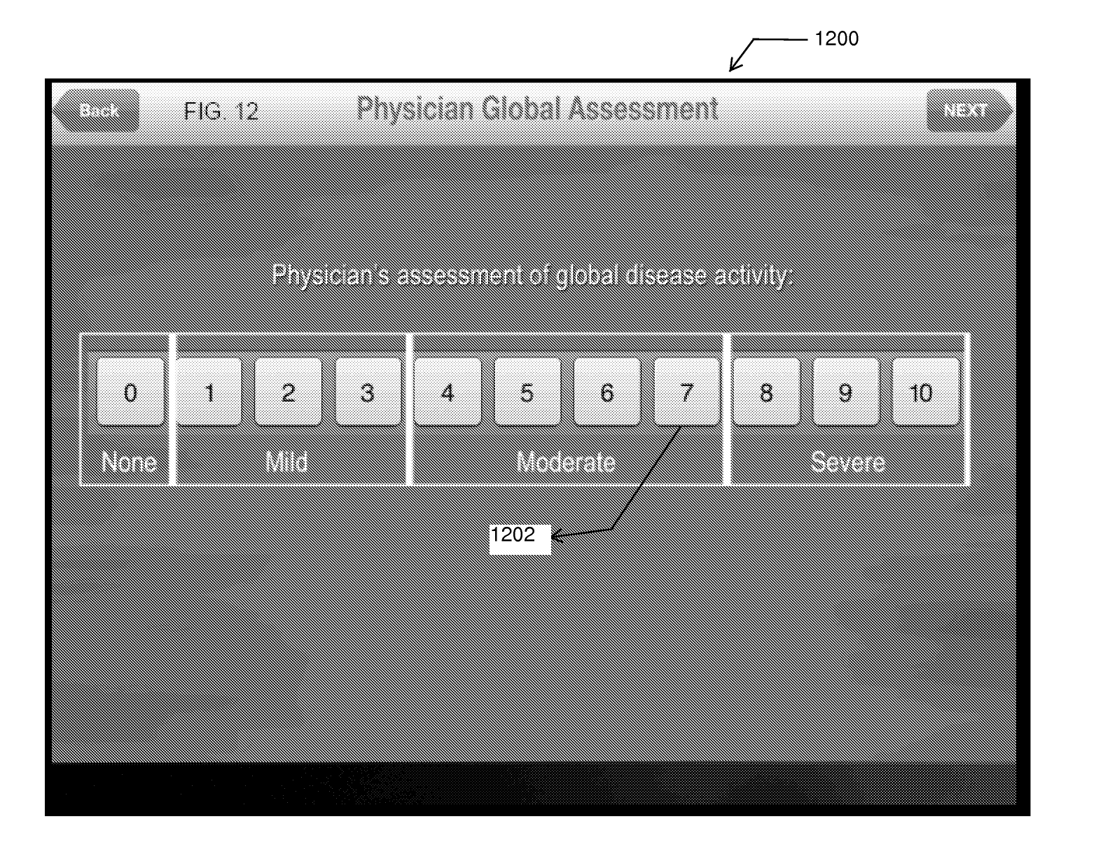

FIG. 12 depicts a physician global assessment data input form 1200. The user, in this case a physician, interacts with the physician global assessment data input form to enter physician global assessment data describing a patient's overall global disease activity. For example, as illustrated, a user, such as a physician, may interact with the physician global assessment data input form 1200 to indicate on a scale from 0 to 10—0 being “none” and 10 being “severe”—that a given patient's overall assessment is moderate at 1202.

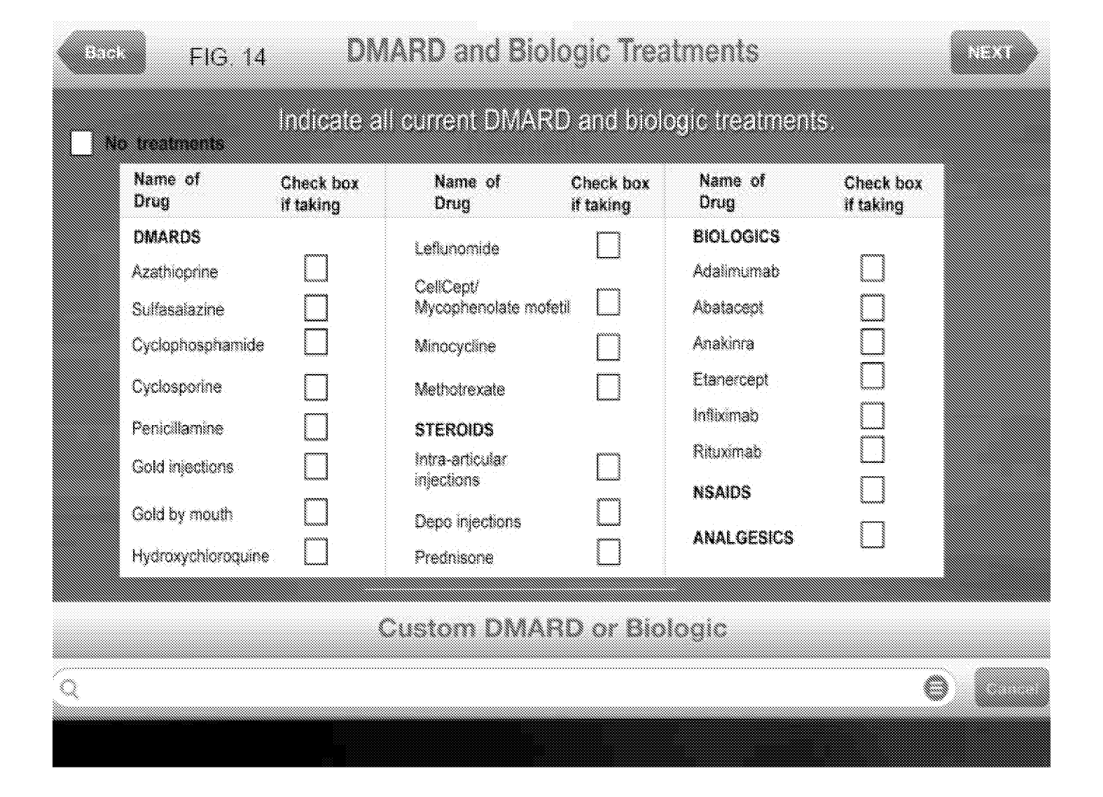

FIG. 14 depicts a biologics data input form. The user of the one or more user devices 102-105 interacts with the biologics input form to input biologics data indicating one or more biologics that may be used as a diagnostic, treatment, and/or agent for a patient.

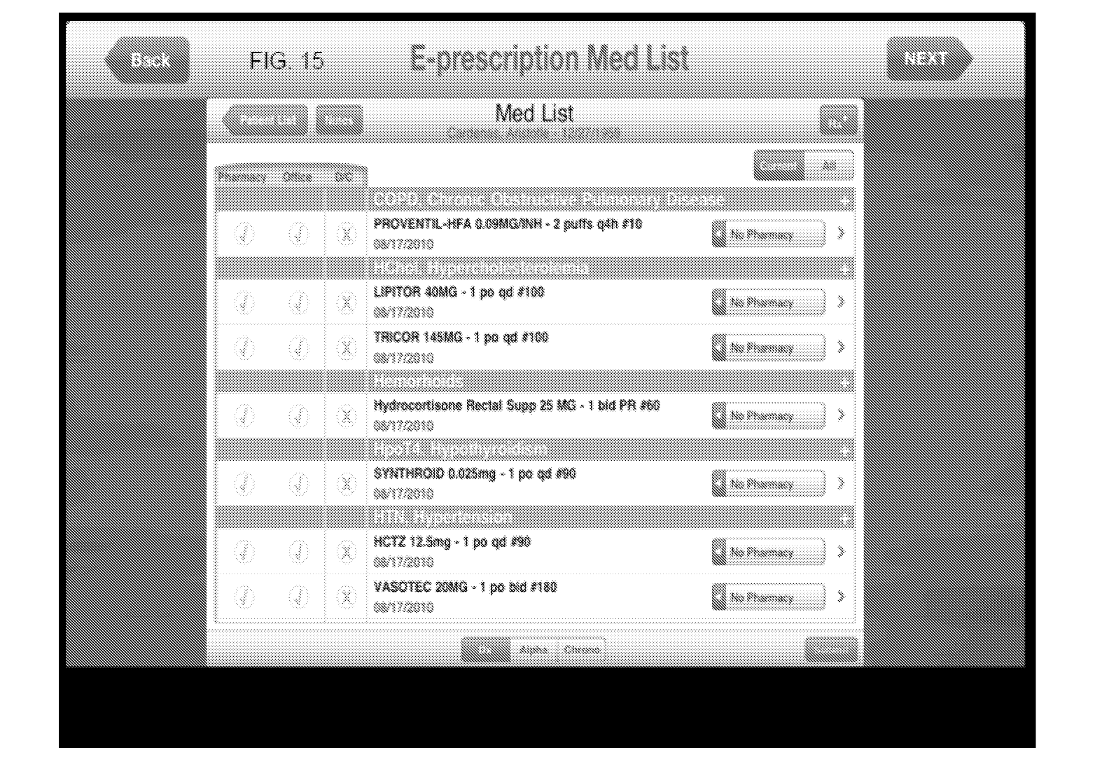

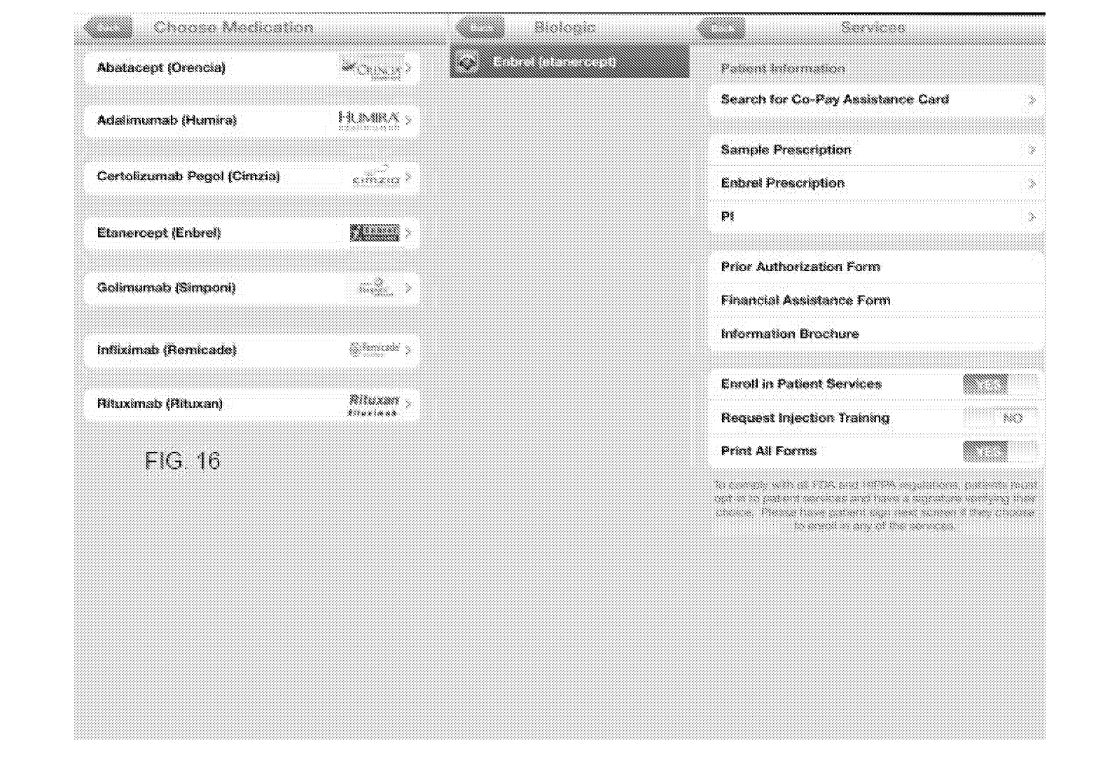

FIGS. 15 and 16 depict a medication input form. The user of the one or more user devices 102-105 interacts with the medication input form to input medication data indicating one or more medications that a patient may require for treatment.

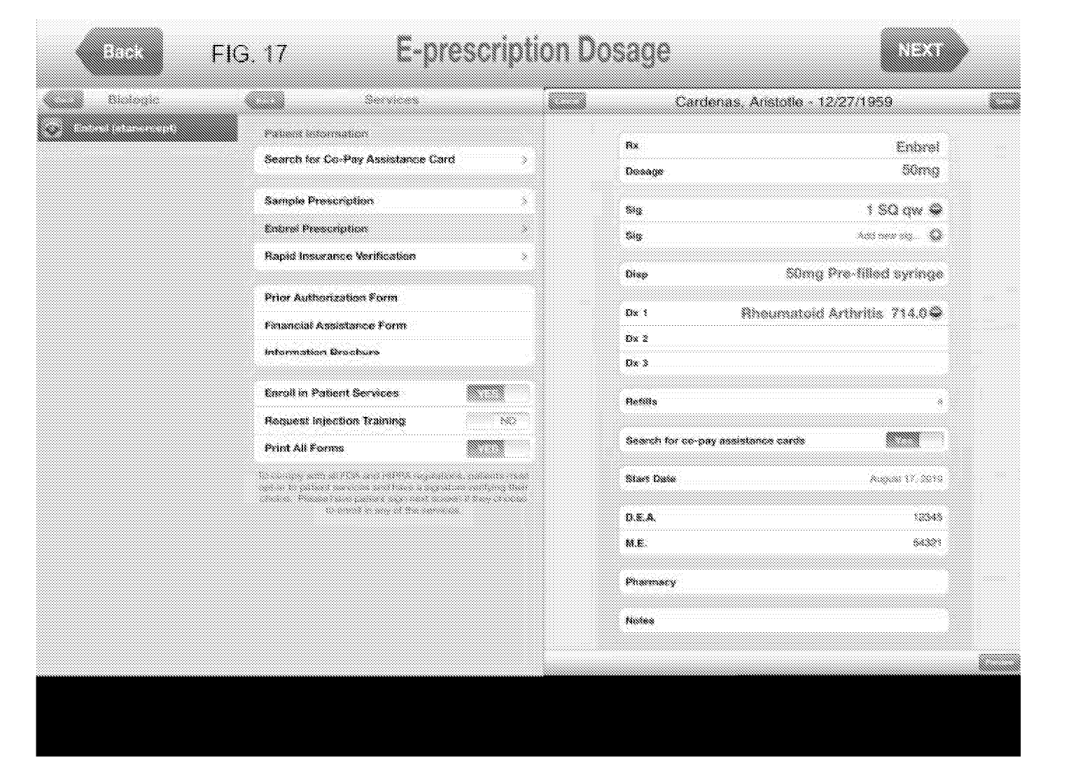

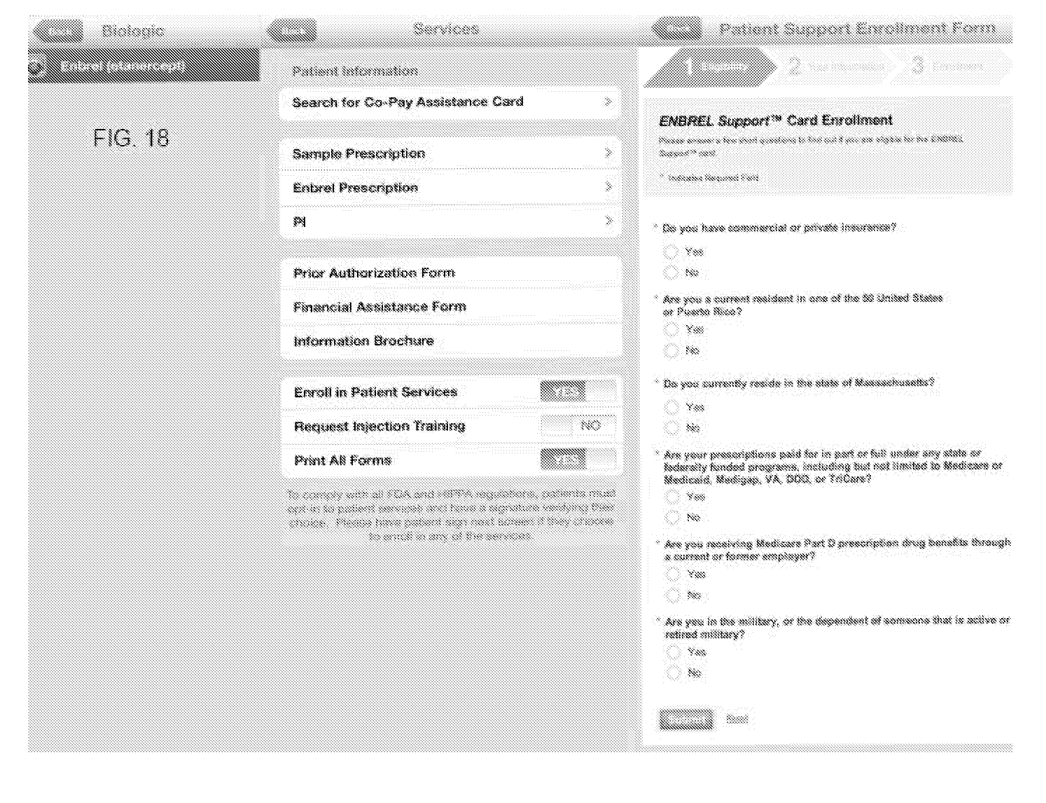

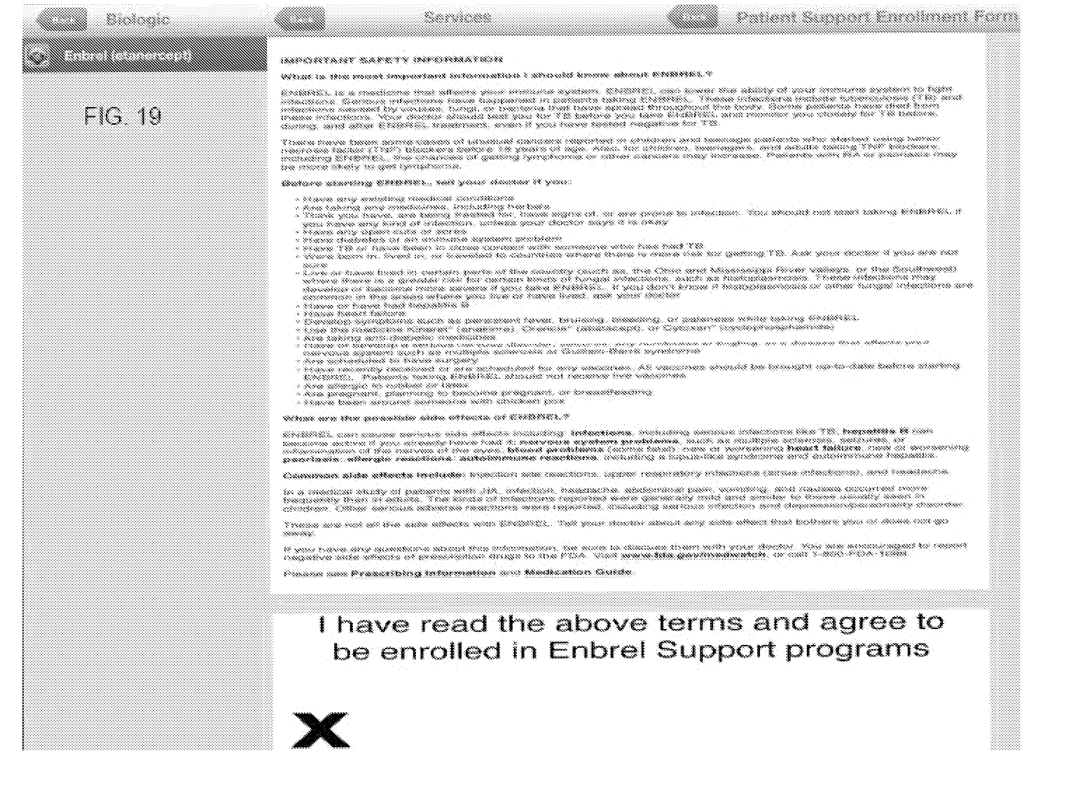

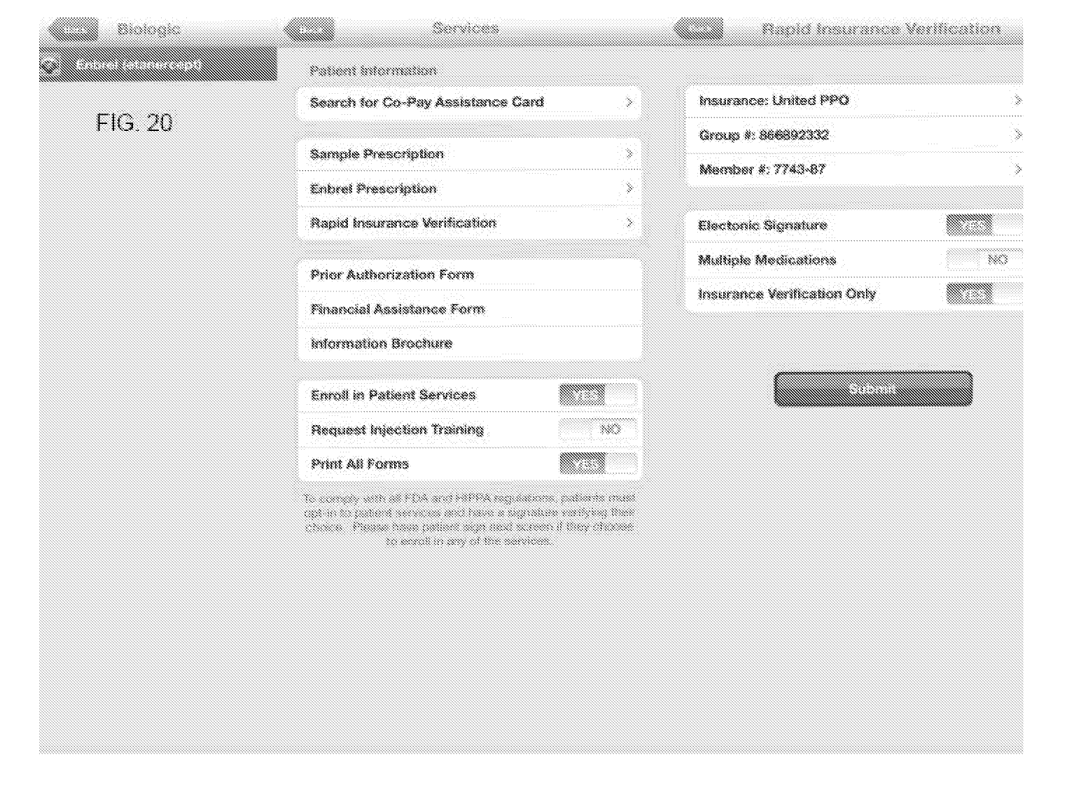

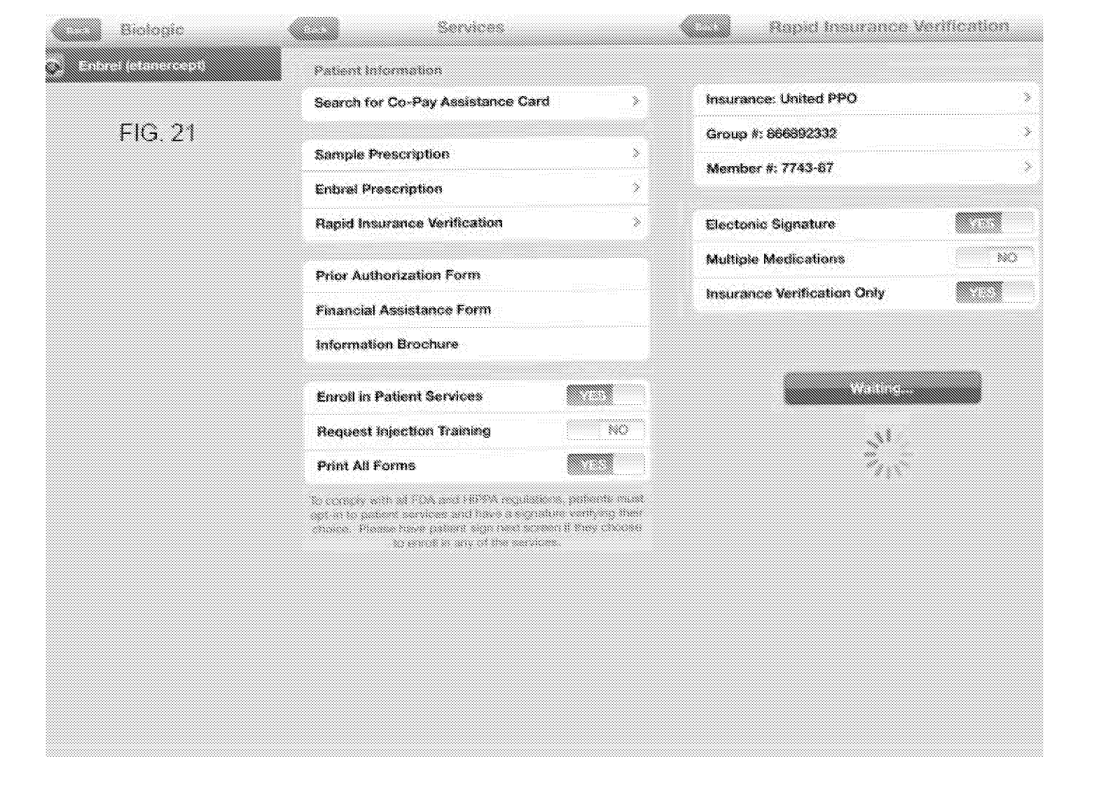

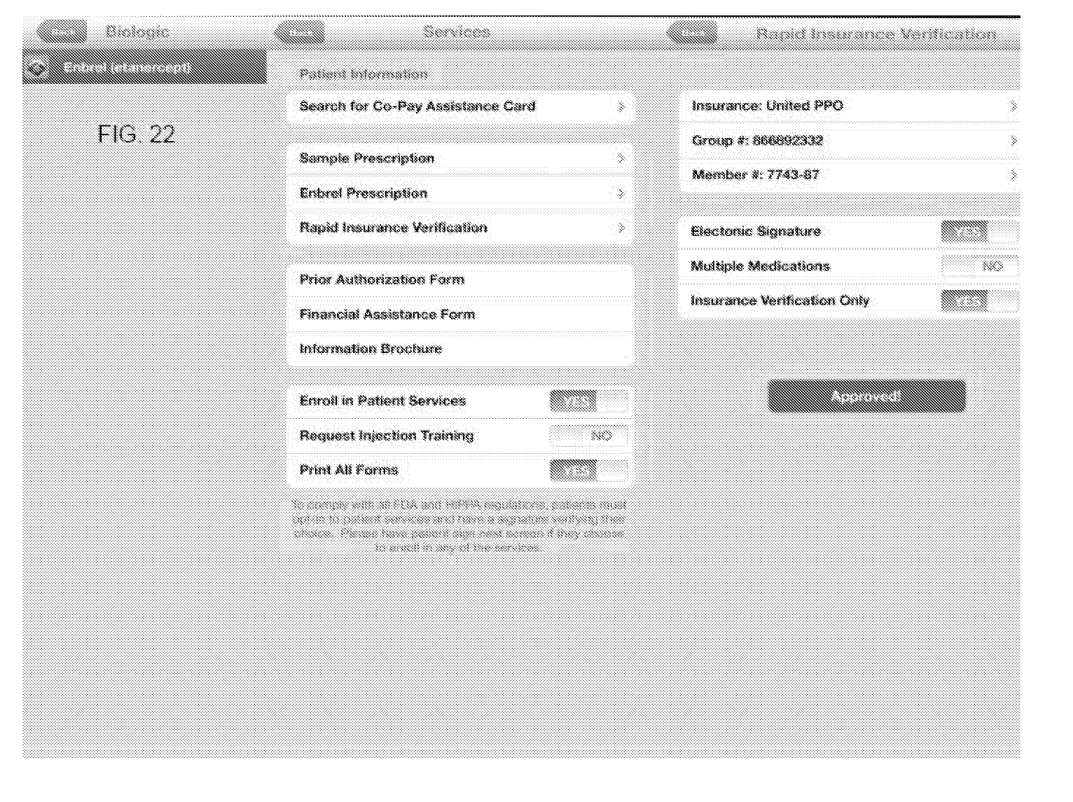

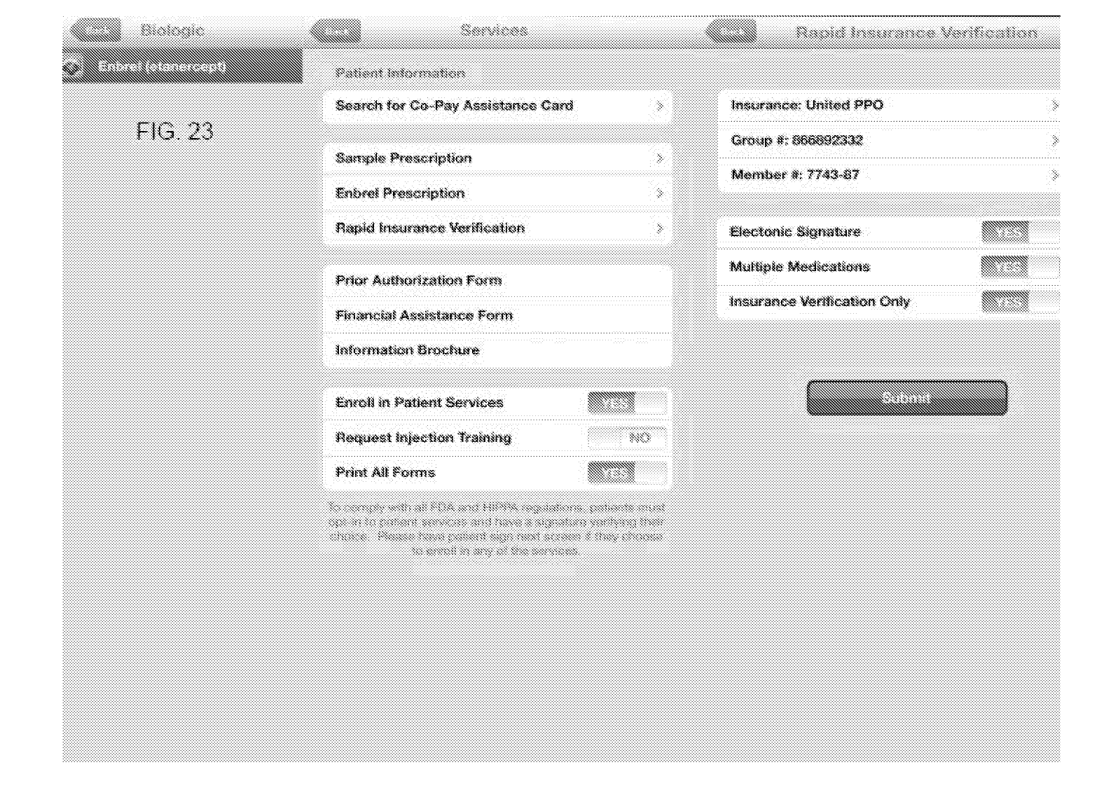

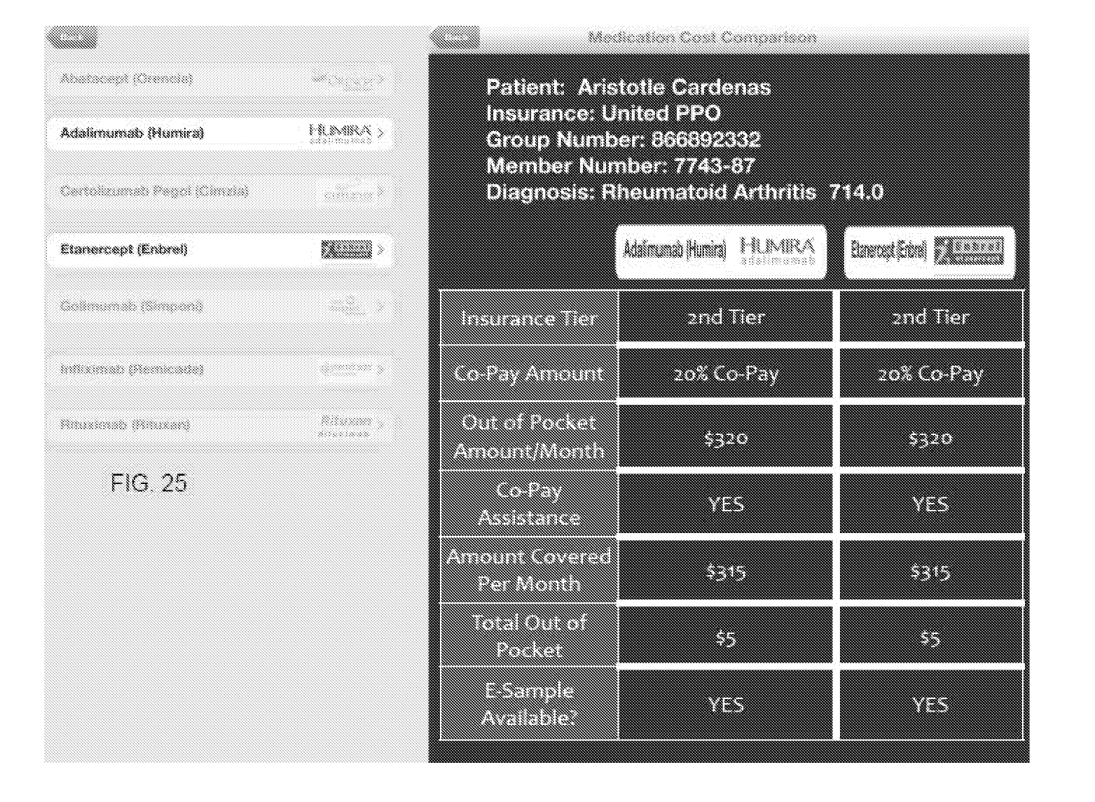

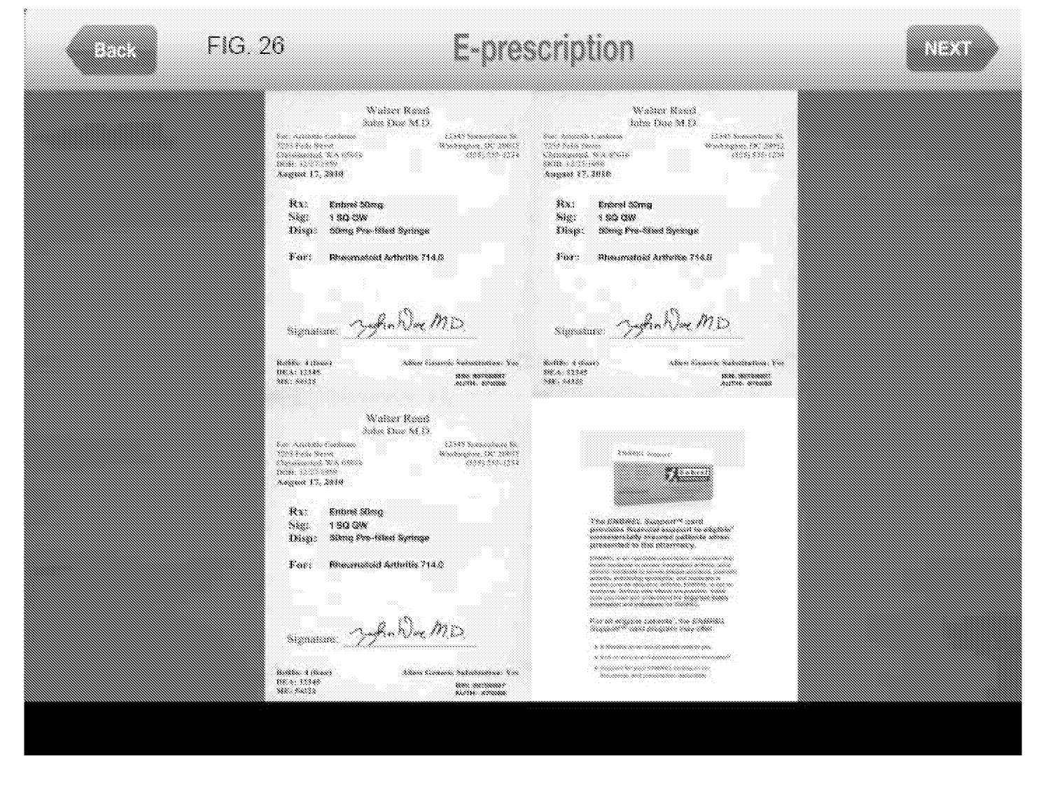

FIGS. 17-23 and 25-26 depict various e-prescription input forms. A user of the one or more user devices 102-105 interacts with the various e-prescription input forms to input prescription data that may be used to automatically prescribe one or more medications that a patient may require for treatment. In one embodiment, the various input forms depicted in FIGS. 17-23 may depict one or more input forms of an external e-prescribing application that has been integrated with the assessment application 108.

The prescription data may be used to mandate which specialty pharmacy will fill the prescription for a particular patient. Encrypted email, VPN tunnel, e-fax, or NCPPD transaction may be used to transmit and/or otherwise communicate the e-prescription and/or prescription data to the desired pharmacy. Alternatively, patient information may be exported into the assessment application 108 to generate a summary sheet and prescription. When a user of the one or more user devices 102-105 saves a patient evaluation, patient information (in .txt or .csv file format) and/or a summary sheet (in .txt or .csv file format) may be downloaded to a secure backend server. Subsequently, when the prescription is written, a bar code may be attached to give the contracted specialty pharmacy access to the files. If a user, such as a Rheumatologist, prefers a non-contracted specialty pharmacy, a print out of the summary sheet and/or PDF may be provided.

Referring back to FIG. 2, a storage module 212 may store the patient data in the data source 110 in response to a received storage request in response to receiving an input, upon an action, and in other instances. For example, if the storage module 212 receives a storage request in response to a user interacting with a health assessment questionnaire input form, the storage module 212 stores the health assessment questionnaire data received via the health assessment questionnaire input form included in the request in the data source 110.

Once all the data from the various input forms has been obtained, an outcome module 214 uses the received data to generate one or more outcome measures. For example, a “joint count” outcome measure may be generated that quantifies the number of swollen joints. As another example, a “number of tender joints” outcome measure may be generated that quantifies the number of tender joints for a patient. A Pain scale outcome measure may be generated that articulates and/or quantifies the amount of pain a patient feels. A mHAQ outcome measure may be generated that quantifies how daily activities may be affecting a particular patient's health. Other HAQ forms may be used including but not limited to HAQ, MDHAQ, HAQII In one example, a Rapid3 outcome measure may be generated. RAPID3 is an outcome measurement tool and is a combination of patient global activity (scale 0-10.0 cm), patient pain (0-10 cm), and Mean MDHAQ (0-3.).

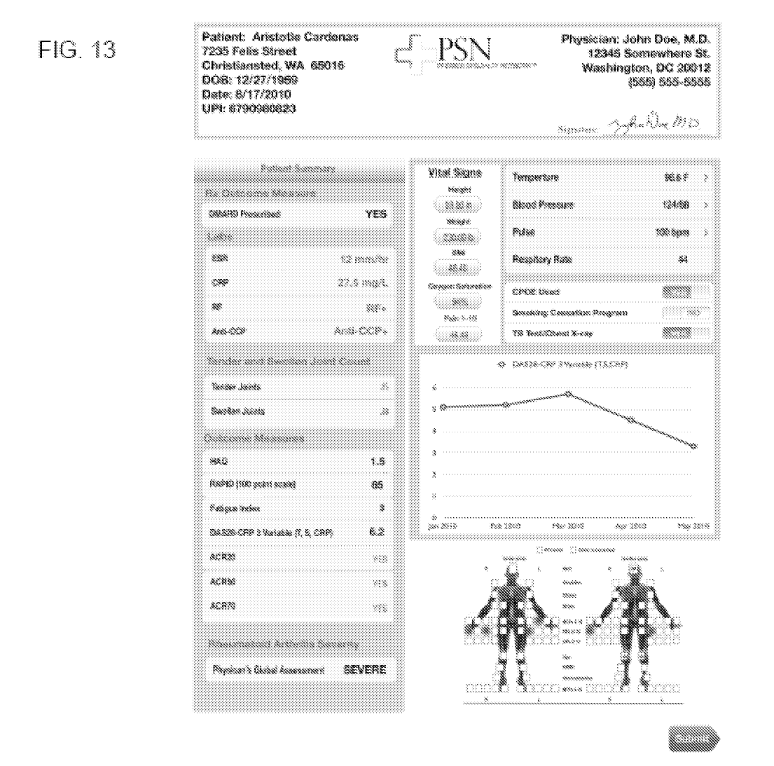

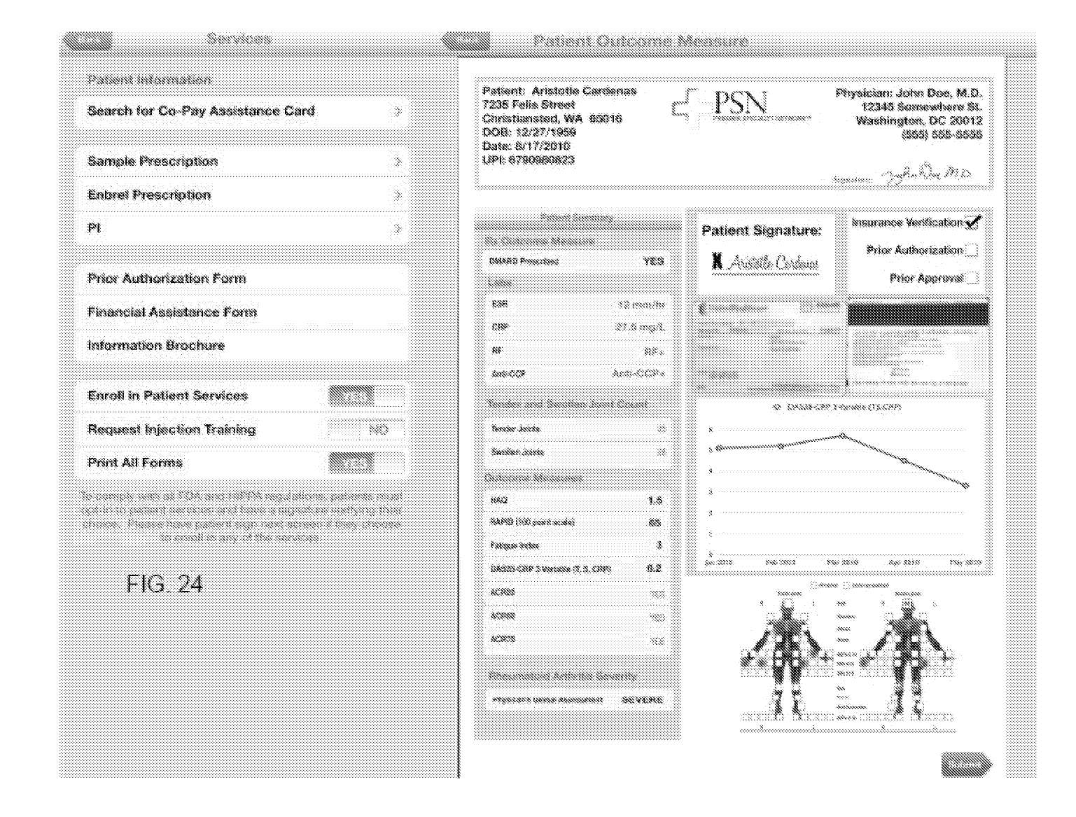

In one embodiment, the outcome measures may be generated as a consolidated summary that provides the patient information in a single page, PDF, and/or file. For example, the consolidated outcome measures summary may provide patient information describing any medications that were prescribed, the number of tender and/or swollen joints, and may illustrate the DAS calculated for a patient graphically, charting the DAS score over time, which allows a user to view the progression or digression of the condition of the patient over a period of time, for which the DAS was calculated. FIGS. 13 and 24 depict illustrative examples of an outcome measures summary.

According to one aspect, once the outcome measures summary has been generated by the outcome module 214, it may be accessed by partners attempting to determine if the patient represented on the outcome measures summary can be approved for insurance purposes. Due to the relatively high cost of the biologic drugs, Insurer's often mandate outcome measurements to verify the medical necessity for payment for a particular patient. Moreover, it is common for Insurers to require a prior authorization before approval and the outcome measures documentation is part of the prior authorization. In addition, a suggested change in dosing strength and/or dosing interval of a particular drug may require an additional approval. For example if a patient is on Remicade at 3 mg/kg every 8 weeks and the Rheumatologist wants to “bump” up the dose to 5 mg/kg every 6 weeks which would almost double the cost, the insurance company may require proof via outcome measures that the increase in dose, interval and cost is warranted.

Additionally, the outcome measures summary may be used to initiate an e-prescription. For example, the assessment application 108 may include an application programming interface (“API”), which may be used to facilitate interaction between the outcome module 214 and any partner systems capable of initiating, processing, and/or filling e-prescriptions. Generally speaking, an API is an interface implemented in software code that defines a particular set of rules and specifications that software programs can follow to communicate with other, different, software programs. As an example, the API may be a collection of commands or functions which enable a user access to functions and services of the assessment application 108 that provide access to any outcome measures summaries that have been generated. Once generated, the API enables the outcomes summary and the e-prescription to be sent individually and/or combined into one file (PDF, .txt, XML, X!2, NCPDP, HL7 formatted) and sent together as a hyperlink, email, QR code/barcode on the summary page or fax.

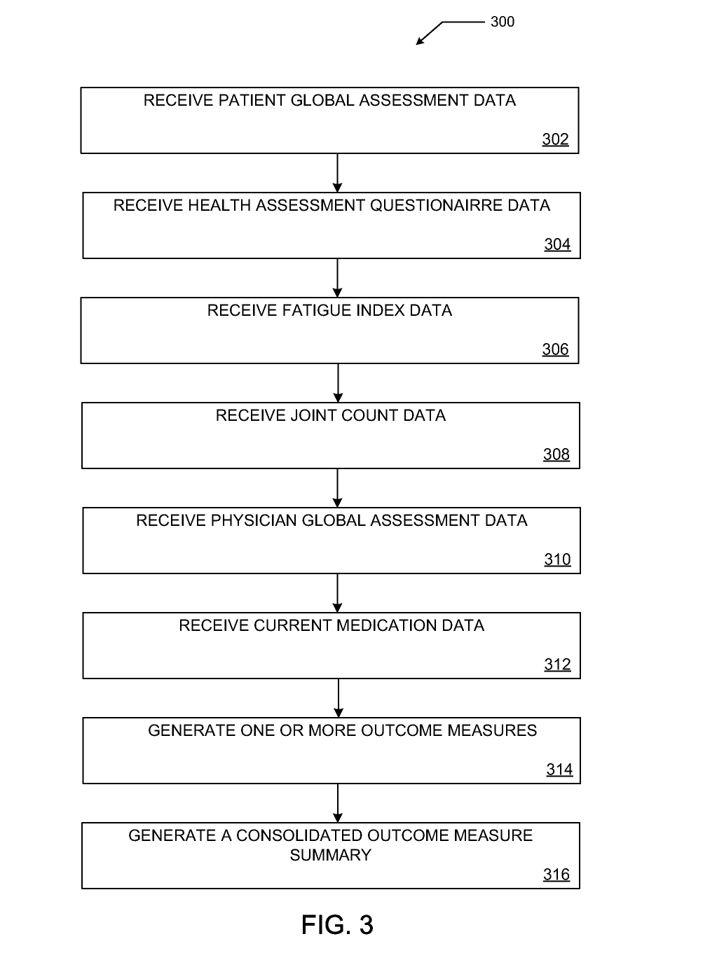

FIG. 3 is a flow chart illustrating an example method 300 for generating outcome measures in the form of a one-page outcome measures summary. Subsequently, the one-page outcome measures summary may be used to initiate functions, such as insurance pre-approval and/or the filling of e-prescriptions. At block 302, patient global assessment data is received describing how a patient is feeling overall in regards to and/or the pain that a patient may be suffering. For example, a patient using the user device 102 inputs patient global assessment data. Health assessment questionnaire data is received at 304. For example, a patient using the user device 102 inputs patient global assessment data, which is transmitted to the assessment application 108. At 306, Fatigue Index data is received via a Fatigue Index data input form. For example, a patient using the user device 102 inputs patient global assessment data, which is transmitted to the assessment application 108 on the server 106.

At block 308, joint count data is received via a Joint Count input form. For example, a patient using the user device 102 inputs a DAS score and joint count data indicating that a patient has 25 tender joints and transmits the joint count data to the assessment application 108. At block 310, physician global assessment data is received numerically indicating a patient's overall global disease activity level. For example, a physician using the user device 102 inputs patient global assessment data that is transmitted to the assessment application 108 on the server 106. At block 312, current medication data is received. For example, a physician using the user device 102 inputs medication data describing the medication a patient may require. At block 314, one or more outcome measures are generated based on the data received by the assessment application 108. For example, a one-page outcome measures summary may be generated with outcome measures at 316 such as: a DAS score, vital signs, an HAQ indicator, and a Fatigue index.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable and executable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. An outcome measures generation system comprising:
at least one processor; and
an assessment application executable by the at least one processor to:
receive a plurality of patient data inputs for a particular patient;
receive a plurality of physician assessments corresponding to the particular patient;
receive lab data from a lab system corresponding to the particular patient;
generate a plurality of outcome measures based on the plurality of patient data inputs, the plurality of physician assessments and the lab data, each outcome measure of the plurality of outcome measures comprising an indication of patient treatment; and
generate for display, a consolidated outcome measures summary comprising at least one of the plurality of outcome measures.

2. The system of claim 1, further comprising transmitting the consolidated outcome measures summary to an insurance provider and the particular patient.

3. The system of claim 1, wherein the lab data comprises a plurality of lab values comprising a rheumatoid factor value, an anti-cyclic citrullinated peptide antibody value, a c-reactive protein value, and a erythrocyte sedimentation rate value.

4. The system of claim 1, wherein the at least one processor is further configured to generate a plurality of input forms to receive the patient data inputs, the plurality of input forms comprising a global health assessment input form, a health assessment questionnaire input form, a fatigue Index input form, and a joint assessment input form.

5. The system of claim 4, wherein the joint assessment input form comprises one or more components for receiving joint count data corresponding to the particular patient, the joint count data for calculating a disease activity score.

6. The system of claim 1, wherein the at least one processor is further configured to generate a plurality of input forms to receive the physician assessments, the plurality of input forms comprising a global assessment data input form.

7. The system of claim 1, wherein the at least one processor is further configured to:
receive prescription data and medication data corresponding to the particular patient; and
generate an e-prescription.

8. A method for generating outcome measures comprising:
receiving, at at least one processor, a plurality of physician assessments corresponding to the particular patient;
receiving, at the at least one processor, lab data from a lab system corresponding to the particular patient;
generating, at the at least one processor, a plurality of outcome measures based on the plurality of patient data inputs, the plurality of physician assessments and the lab data, each outcome measure of the plurality of outcome measures comprising an indication of patient treatment; and
generating for display, at the at least one processor, a consolidated outcome measures summary comprising at least one of the plurality of outcome measures.

9. The method of claim 8, further comprising transmitting the consolidated outcome measures summary to an insurance provider and the particular patient.

10. The method of claim 8, wherein the lab data comprises a plurality of lab values comprising a rheumatoid factor value, an anti-cyclic citrullinated peptide antibody value, a c-reactive protein value, and a erythrocyte sedimentation rate value.

11. The method of claim 8, further comprising generating a plurality of input forms to receive the patient data inputs, the plurality of input forms comprising a global health assessment input form, a health assessment questionnaire input form, a fatigue Index input form, and a joint assessment input form.

12. The method of claim 11, wherein the joint assessment input form comprises one or more components for receiving joint count data corresponding to the particular patient, the joint count data for calculating a disease activity score.

13. The method of claim 8, further comprising generating a plurality of input forms to receive the physician assessments, the plurality of input forms comprising a global assessment data input form.

14. The method of claim 8, further comprising receiving prescription data and medication data corresponding to the particular patient; and
generate an e-prescription.

15. An outcome measures generation system comprising:
at least one processor; and
an assessment application executable by the at least one processor to:
receive a plurality of patient data inputs for a particular patient;
receive a plurality of physician assessments corresponding to the particular patient;
receive lab data from a lab system corresponding to the particular patient;
generate a plurality of outcome measures based on the plurality of patient data inputs, the plurality of physician assessments and the lab data, each outcome measure of the plurality of outcome measures comprising an indication of patient treatment; and
generate for display, a consolidated outcome measures summary comprising at least one of the plurality of outcome measures; and
transmitting the consolidated outcome measures summary to an insurance provider and the particular patient.

16. The system of claim 15, wherein the lab data comprises a plurality of lab values comprising a rheumatoid factor value, an anti-cyclic citrullinated peptide antibody value, a c-reactive protein value, and a erythrocyte sedimentation rate value.

17. The system of claim 15, wherein the at least one processor is further configured to generate a plurality of input forms to receive the patient data inputs, the plurality of input forms comprising a global health assessment input form, a health assessment questionnaire input form, a fatigue Index input form, and a joint assessment input form.

18. The system of claim 18, wherein the joint assessment input form comprises one or more components for receiving joint count data corresponding to the particular patient, the joint count data for calculating a disease activity score.

19. The system of claim 15, wherein the at least one processor is further configured to generate a plurality of input forms to receive the physician assessments, the plurality of input forms comprising a global assessment data input form.

20. The system of claim 15, wherein the at least one processor is further configured to:
receive prescription data and medication data corresponding to the particular patient; and
generate an e-prescription.
